(19) United States
(12) Patent Application Publication
(10) Pub. No.: US 2010/0083793 A1
(43) Pub. Date: Apr. 8, 2010

(54) Lifting mechanism for an exercise apparatus

(76) Inventor: Chen-Hui Ko, Taoyuan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/285,436

(22) Filed: Oct. 6, 2008

(51) Int. Cl. F16H 35/00

(52) U.S. Cl. 74/640

(57) ABSTRACT

A lifting mechanism for an exercise apparatus frame base includes a housing made of lightweight material with a positioning cavity having a through hole. A covering cap having a circular internal rim is integrally formed within the positioning cavity and made by high strength material an injection molding process is performed. The bottom of the covering cap includes an axle hole corresponding to the through hole. The top of the covering cap has an opening with a positioning flange extending outwards. In this way, the drawback that the inside of the conventional plastic housing is easily damaged by the transmission gear can be eliminated. As a result, the weight can be minimized and the strength can be maintained.

### BACKGROUND OF THE INVENTION

1. Field of the Invention

The invention relates to a lifting mechanism for an exercise apparatus, and more particularly, to a circular covering cap 13 the portion of which is not subject to force being made of lightweight material while the portion of which is subject to force being made of high strength material.

2. Description of the Related Art

Most of the conventional exercise apparatuses include a lifting mechanism to adjust its inclination relative to a horizontal plane. In order to facilitate the operation thereof, a motor is employed to drive a reduction gearset for imparting rotational motion to a lifting element. In this way, a desired angle is achieved.

The reduction gear of the conventional transmitting and lifting mechanism is completely made of metal by the casting process, thereby considerably increasing the production cost in addition to the increase of weight. In order to avoid the drawbacks, a lifting mechanism 70 disclosed in U.S. Pat. No. 6,964,632 includes a housing 71 accommodating the reduction gear is made of plastic by the injection molding process. A supporting piece 73 is provided at the external side of a through hole 72 and secured by bolts 74 for enhancing the strength of the through hole 72. However, when a driving gear (not shown) disposed within the plastic housing 71 drives a spindle 75 into rotation, a threaded sleeve will generate the torsional type friction acting on the internal wall of the housing 71, thereby leading to damage with fracture. This requires further improvement.

### SUMMARY OF THE INVENTION

An object of the invention is to provide a lifting mechanism for an exercise apparatus that includes a housing with portion subject to force being made of high strength material. Moreover, the high strength material is applied to the internal wall of the plastic housing in such a way that the internal transmission gear is in contact of the high strength material rather than in contact of the housing. As a result, the plastic housing can achieve the effect of reducing weight. Meanwhile, the strength can be maintained such that no fracture takes place. Furthermore, a prolonged service life is ensured.

In order to achieve the above-mentioned object, a lifting mechanism for an exercise apparatus frame base includes a housing made of lightweight material with a positioning cavity having a through hole. A covering cap having a circular internal rim is integrally formed within the positioning cavity and made by high strength material an injection molding process is performed. The bottom of the covering cap includes an axle hole corresponding to the through hole. The top of the covering cap has an opening with a positioning flange extending outwards. In this way, the drawback that the inside of the conventional plastic housing is easily damaged by the transmission gear can be eliminated. As a result, the weight can be minimized and the strength can be maintained.

### BRIEF DESCRIPTION OF THE DRAWINGS

The accomplishment of this and other objects of the invention will become apparent from the following descriptions and its accompanying figures of which:

FIG. 1 is an exploded perspective view of a conventional structure according to U.S. Pat. No. 6,964,632;

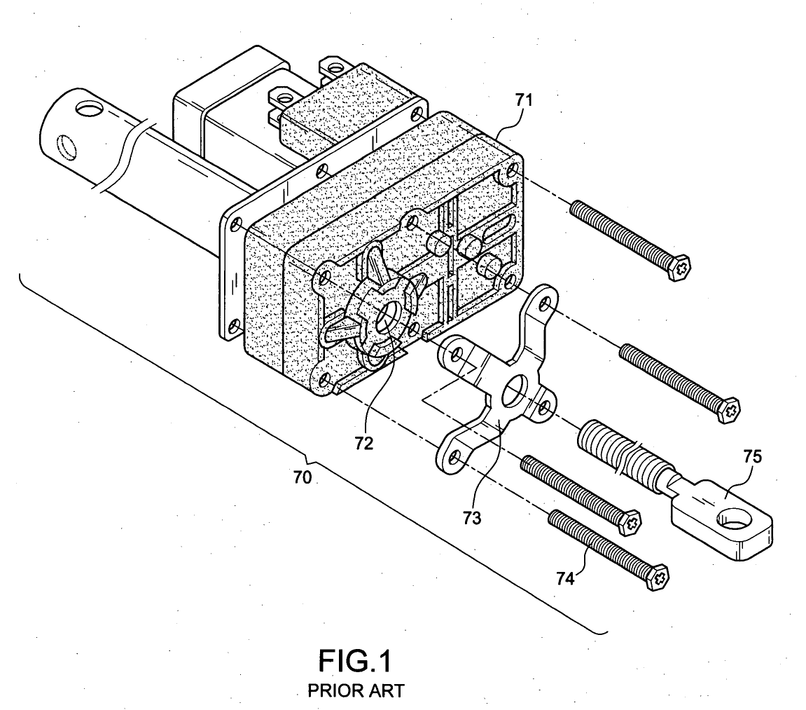

FIG. 2 is an exploded perspective view of the structure of the housing in accordance with the invention;

FIG. 3 is another exploded perspective view of the structure of the housing in accordance with the invention;

FIG. 4 is a perspective view of the structure in accordance with the invention;

FIG. 5 is a schematic drawing of the invention with partial structure in cross-sectional view; and

FIG. 6 is a perspective view of the invention employed for adjusting the angle of elevation of a platform of a treadmill.

### DETAILED DESCRIPTION OF THE PREFERRED EMBODIMENT

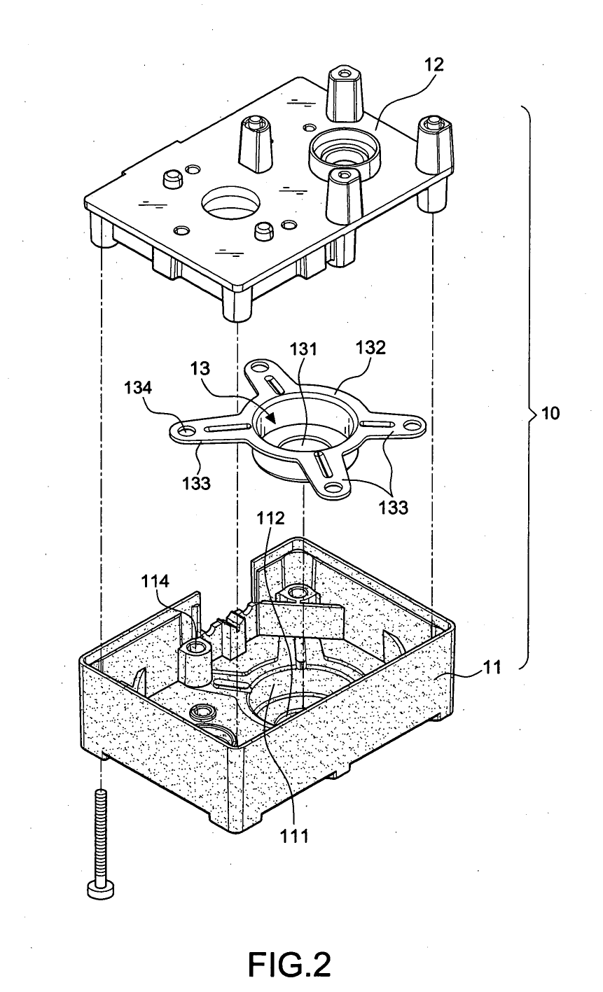

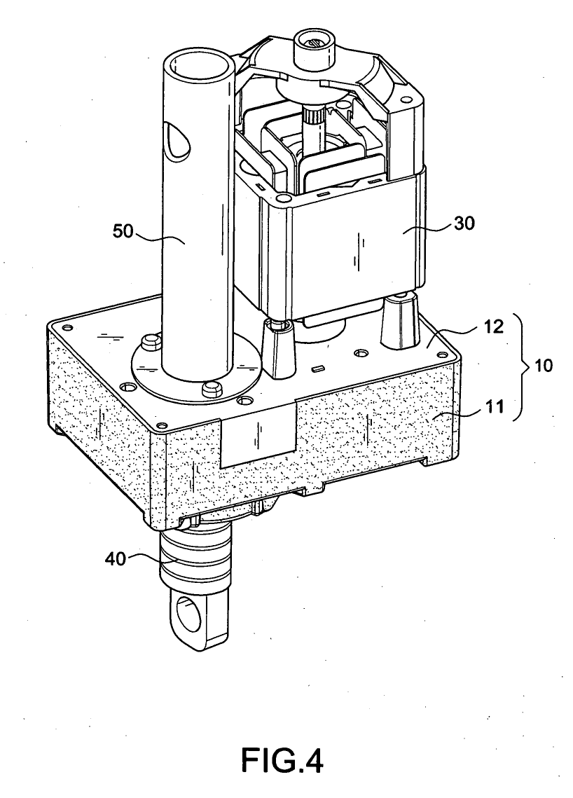

First of all, referring to FIGS. 2 through 5, a lifting mechanism for an exercise apparatus in accordance with the invention includes a housing 10. The housing 10 consists of a frame base 11 with an opening surface and a cover plate 12. The frame base 11 is made of lightweight material, such as plastic, acrylonitrile butadiene styrene (ABS), etc. The frame base 11 includes a positioning cavity 111 with a through hole 112. A covering cap 13 is integrally formed within the positioning cavity 111. Meanwhile, the covering cap 13 is made by high strength material such as steel plates. Moreover, the covering cap 13 has a circular internal rim. The bottom of the covering cap 13 includes an axle hole 131 corresponding to the through hole 112. The top of the covering cap 13 has an opening with a positioning flange 132 extending outwards. At least one positioning claw 133 is extended from the positioning flange 132. The cover plate 12 is also formed by high strength material such as steel plates.

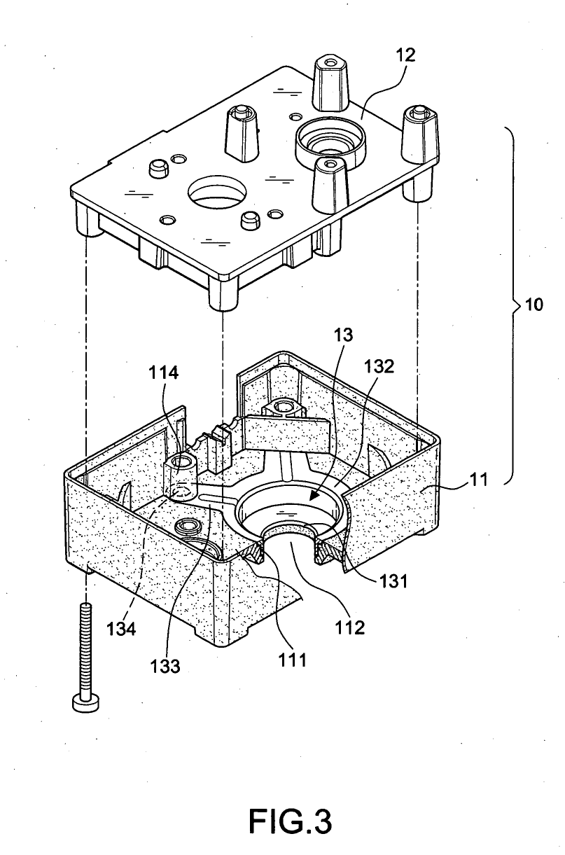

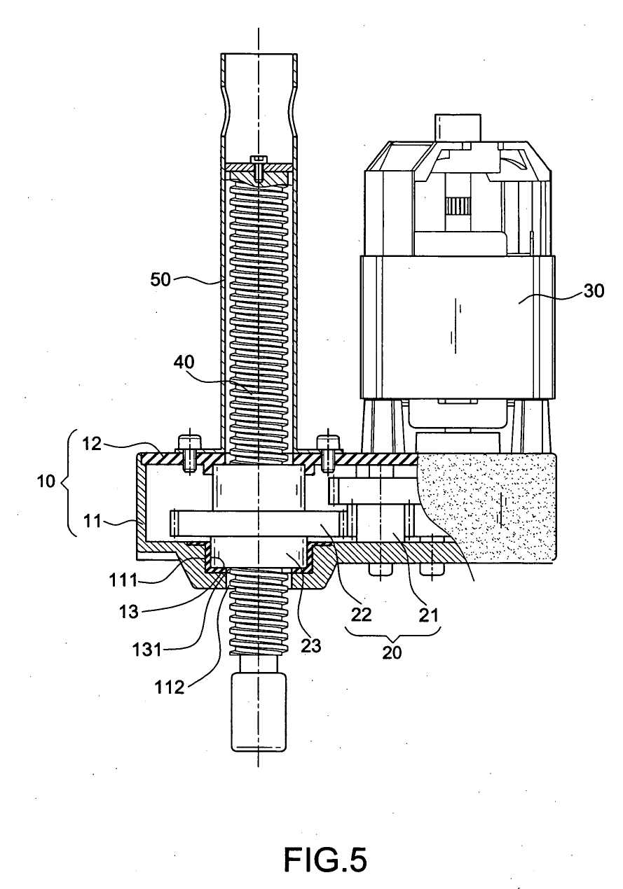

The covering cap 13 illustrated in FIG. 2 is intentionally detached from the frame base 11. In fact, the covering cap 13 is received within an injection molding tool and is integrally formed with the frame base 11. In this way, both of them can be tightly joined together in a body for enhancing the strength thereof. The positioning claw 133 includes a screw hole 134 at the external end thereof. As shown in FIG. 3, the positioning claws 133 and the circular covering cap 13 are integrally formed at the internal wall of the frame base 11 when the frame base 11 is formed by the injection molding process. The screw holes 134 are secured to the bottom end of positioning posts 114 projecting from the internal wall of the frame base 11. That is, the covering cap 13 is integrated into the frame base 11. As a result, a stable structure is ensured. Moreover, it is not visible when seen from the external side. Therefore, an aesthetically appealing appearance is achieved. What is more important, is that the lifting mechanism in accordance with the invention can effectively eliminate the drawbacks of the prior art. As shown in FIG. 5, a transmission gear 22 includes a threaded sleeve 23 mounted on a threaded rod 40. The torque created by the rotation of the threaded sleeve 23 acts on the internal wall of the covering cap 13 without contact with the frame base 11 and the through hole 112. Therefore, a reliable protection of the lightweight frame base 11 from damage is achieved.

In order to achieve a problem-free operation of the invention, a transmission unit 20, a motor 30, a transmission rod 40, and a fixing sleeve 50 have to be provided.

The transmission unit 20 includes a reduction gear set 21 and a transmission gear 22 disposed within the housing 10. One end of the transmission gear 22 is positioned within the covering cap 13 while the other end thereof is fixed by the cover plate 12 in place.

The motor 30 is positioned at the external side of the housing 10 for supplying power to the transmission unit 20.

The transmission rod 40 passes through the housing 10 and is engaged with the transmission gear 22. According to the embodiment, the transmission rod 40 is a threaded rod. In other words, the transmission gear 22 is driven by the motor 30 via the reduction gear set 21. Thereafter, the transmission rod 40 is driven by the internal thread of the transmission gear 22 for an axial movement. This is the general mechanic principle so that no further descriptions thereto are given hereinafter.

The fixing sleeve 50 is disposed at the external side of the housing 10 and mounted on one end of the transmission rod 40.

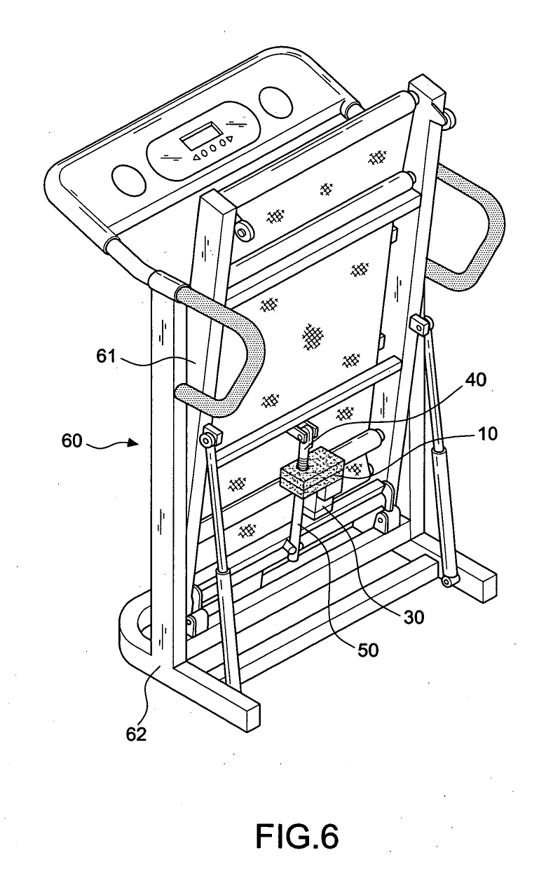

Based on the above-mentioned construction, the lifting mechanism can be employed for adjusting the angle of elevation (see FIG. 6). The end of the transmission rod 40 and the fixing sleeve 50 are pivotally attached to a platform 61 and a fixing base 62, respectively. The adjustment of the angle of elevation is done by the transmission of the power of the motor via the reduction gear set 21 to the transmission gear 22 such that the transmission rod 40 is extended or retracted relative to the fixing sleeve 50. In this way, the distance between the end of the transmission rod 40 and the fixing sleeve 50 is changed for adjusting the angle of elevation of the platform 61.

When the transmission rod 40 is extended or retracted, the pushing force will be transmitted by the end of the transmission gear 22 to the covering cap 13 and the cover plate 12 of the housing 10. According to the invention, the covering cap 13 and the cover plate 12 of the housing 10 subject to the pushing force of the transmission rod 40 are made of high strength material for creating a considerable structural strength to overcome the pushing force generated by the transmission rod 40. Meanwhile, the other portion of the housing 10 that is not subject to force can be made of lightweight material for minimizing the entire weight of the housing 10. As a result, the necessary strength can be maintained to achieve an easy movement. In addition, the material cost can be reduced. Consequently, the lifting mechanism in accordance with the invention has the advantages of reducing the weight and maintaining the necessary strength.

What is claimed is:

1. A lifting mechanism for an exercise apparatus, comprising:
a) a housing consisting of a frame base with an opening surface and a cover plate, the frame base being made of lightweight material, the frame base having a positioning cavity with a through hole, a covering cap having a circular internal rim being integrally formed within the positioning cavity and made by high strength material, the bottom of the covering cap having an axle hole corresponding to the through hole, the top of the covering cap having an opening with a positioning flange extending outwards, and the cover plate being formed by high strength material such as steel plates as well;
b) a transmission unit having a reduction gear set and a transmission gear disposed within the housing, one end of the transmission gear being positioned within the covering cap while the other end thereof is fixed by the cover plate in place;
c) a motor being positioned at the external side of the housing for supplying power to the transmission unit;
d) a transmission rod passing through the housing and engaged with the transmission gear; and
e) a fixing sleeve disposed at the external side of the housing and mounted on one end of the transmission rod.

2. The lifting mechanism for an exercise apparatus as recited in claim 1 wherein at least one positioning claw is extended from the positioning flange, and wherein the positioning claw includes a screw hole at the external end thereof, and wherein the positioning claws and the circular covering cap are integrally formed at the internal wall of the frame base when the frame base is formed by the injection molding process, and wherein the screw holes are secured to the bottom end of positioning posts projecting from the internal wall of the frame base.

3. The lifting mechanism for an exercise apparatus as recited in claim 1 wherein the transmission rod is a threaded rod.

4. The lifting mechanism for an exercise apparatus as recited in claim 1 wherein the high strength material of the covering cap and the cover plate includes steel plates.
